(19) United States
(12) Patent Application Publication
(10) Pub. No.: US 2024/0350955 A1
(43) Pub. Date: Oct. 24, 2024

(54) AIR PURIFIER

(71) Applicant: Guangzhou Fengruijing Technology Device Co., Ltd., Guangzhou (CN)

(72) Inventor: Zhongshu Xie, Guangzhou (CN)

(21) Appl. No.: 18/640,431

(22) Filed: Apr. 19, 2024

(30) Foreign Application Priority Data
Apr. 23, 2023 (CN) 202320951909.X

(51) Int. Cl. B01D 46/12; B01D 46/00; B01D 46/58

(52) U.S. Cl. CPC B01D 46/12; B01D 46/0005; B01D 46/0047; B01D 46/58; B01D 2265/024; B01D 2273/30; B01D 2275/205

(57) ABSTRACT

The present invention provides an air purifier, and relates to the technical field of air purifiers. The air purifier comprises an air filter box with openings at a top and a bottom, and further comprises a top plate covering the opening at the top of the air filter box and a bottom plate covering the opening at the bottom of the air filter box. The top plate and the bottom plate are both detachably connected with the air filter box; the top plate is provided with an air inlet and outlet; and the top plate is provided with an air extraction assembly located at the air inlet and outlet. By adopting the present invention, the air purifier is convenient to detach and install and is conveniently placed in a suitcase, etc. for carrying; using locations of the air purifier are flexible; and convenience is brought to use by a user.

### CROSS-REFERENCE TO RELATED APPLICATIONS

This application claims priority to Chinese Patent Application No. 202320951909.X, filed on Apr. 23, 2023, which is hereby incorporated by reference in its entirety.

### TECHNICAL FIELD

The present invention relates to the technical field of air purifiers, and specifically relates to an air purifier.

### BACKGROUND

Air purifiers, also known as “air cleaners”, air fresheners and purifiers, are products capable of adsorbing, decomposing or converting various air pollutants (generally including PM2.5 particles, dust, pollen, odors, decoration pollutants such as formaldehyde, bacteria, allergens and the like) to effectively improve air cleanliness, and are mainly divided into household products, commercial products, industrial products and building products.

The existing air purifiers have relatively fixed structures. Some air purifiers can be disassembled, but screwdrivers and other detachment tools are generally required to be used, such that operation is troublesome. Some other air purifiers cannot be detached, but are large in volume and inconvenient to carry.

### SUMMARY

The purpose of the present invention is to provide an air purifier, which is able to provide solutions in view of shortcomings of the prior art. The air purifier is convenient to detach and install, no additional tools require to be used in detaching and installing processes, the air purifier is easy to operate, has a small volume after the completion of detaching, and is conveniently placed in a suitcase, etc. for carrying, using locations of the air purifier are flexible, and convenience is brought to use by a user.

Technical solutions adopted by the present invention are as follows.

An embodiment of the present application provides an air purifier. The air purifier comprises an air filter box with openings at a top and a bottom, and further comprises a top plate covering the opening at the top of the above air filter box and a bottom plate covering the opening at the bottom of the above air filter box. The above top plate and the above bottom plate are both detachably connected with the above air filter box; and the above top plate is provided with an air inlet and outlet, and the above top plate is provided with an air extraction assembly located at the above air inlet and outlet.

Further, in some embodiments of the present invention, the above air extraction assembly comprises at least one fan, and the above fan is arranged on the above top plate and located at the above air inlet and outlet.

Further, in some embodiments of the present invention, a bottom of the above top plate is provided with a first limiting frame, and the above air filter box is located in the above first limiting frame and abuts against an inner side wall of the above first limiting frame.

Further, in some embodiments of the present invention, a top of the above bottom plate is provided with a second limiting frame, and the above air filter box is located in the above second limiting frame and abuts against an inner side wall of the above second limiting frame.

Further, in some embodiments of the present invention, the top of the above bottom plate is provided with clamping blocks, and the above air filter box abuts between the above clamping blocks and the above second limiting frame.

Further, in some embodiments of the present invention, the above air filter box comprises a plurality of air filter screens, and the plurality of air filter screens above sequentially abut against each other and surround to form the above air filter box.

Further, in some embodiments of the present invention, a number of the above air filter screens is four, and a cross section of the above air filter box is rectangular.

Compared with the prior art, the embodiments of the present invention at least have the following advantages or beneficial effects.

An embodiment of the present invention provides an air purifier. The air purifier comprises an air filter box with openings at a top and a bottom, and further comprises a top plate covering the opening at the top of the above air filter box and a bottom plate covering the opening at the bottom of the above air filter box. The above top plate and the above bottom plate are both detachably connected with the above air filter box; and the above top plate is provided with an air inlet and outlet, and the above top plate is provided with an air extraction assembly located at the above air inlet and outlet.

In actual use, the various air filter screens are sequentially placed vertically at the top of the bottom plate, and the air filter screens are close to an outer side wall of a bottom and abut against an inner side wall of the second limiting frame. In this way, the various air filter screens are sequentially installed at the top of the bottom plate, and the various air filter screens can sequentially undergo abutting. Then, the top plate is covered at the top of the air filter box, and an outer side wall, close to a top edge, of the air filter box abuts against an inner side wall of the first limiting frame of the top plate. In this way, the air filter box is clamped and fixed by the top plate and the bottom plate, and installation of the entire air purifier is completed. No additional tools require to be used in a whole installation process, only hands are required to be used for operation, and the operation is simple.

After the air purifier is installed, the fan is turned on. The fan rotates and blows air in the air filter box to an outside after being turned on. At this time, a negative pressure is generated in the air filter box. Under the action of the negative pressure, indoor air can be filtered by the various air filter screens, flows into the air filter box and is blown out by the fan, such that surrounding air is filtered and purified, and cleanliness of the indoor air is improved.

When the air purifier needs to be carried, only the top plate needs to be manually moved upwards with hands, and the various air filter screens are taken out from the bottom plate. At this time, the air purifier is detached into a plurality of flat-shaped structures, which is small in volume after the completion of detaching and can be placed in a suitcase, etc. for carrying, using locations of the air purifier are flexible, and convenience is brought to use by a user.

### BRIEF DESCRIPTION OF THE DRAWINGS

In order to explain the technical solutions of the embodiments of the present invention more clearly, drawings required to be used in the embodiments are briefly introduced below. It should be understood that the following drawings only show some embodiments of the present invention and therefore should not be regarded as limitations of the scope. For persons of ordinary skill in the art, other relevant drawings can also be obtained without exerting creative efforts according to these drawings.

FIG. 1 is an exploded diagram of an air purifier provided in an embodiment of the present invention;

FIG. 2 is a schematic structural diagram of an air purifier without a fan provided in an embodiment of the present invention;

FIG. 3 is a schematic structural diagram without a top plate in FIG. 2;

FIG. 4 is a schematic structural diagram of a bottom of a top plate provided in an embodiment of the present invention;

FIG. 5 is a first schematic structural diagram of a bottom of a bottom plate provided in an embodiment of the present invention; and

FIG. 6 is a second schematic structural diagram of a bottom of a bottom plate provided in an embodiment of the present invention.

Numerals are as follows: 1, top plate; 2, bottom plate; 3, air inlet and outlet; 4, fan; 5, first limiting frame; 6, second limiting frame; 7, clamping block; 8, air filter screen.

### DESCRIPTION OF EMBODIMENTS

In order to make the purpose, technical solutions and advantages of the embodiments of the present invention clearer, the technical solutions in the embodiments of the present invention are described clearly and completely below in conjunction with the drawings in the embodiments of the present invention. Obviously, the described embodiments are only a part of the embodiments of the present invention, rather than all of the embodiments. Components in the embodiments of the present invention generally described and illustrated in the drawings herein may be arranged and designed in a variety of different configurations.

Therefore, the following detailed description of the embodiments of the present invention provided in the drawings is not intended to limit the scope of the present invention claimed for protection, but only shows selected embodiments of the present invention. On the basis of the embodiments of the present invention, all other embodiments obtained by persons of ordinary skill in the art without exerting creative efforts should fall within the scope of protection of the present invention.

It should be noted that similar reference numerals and letters represent similar items in the following drawings. Therefore, once an item is defined in one figure, the item is not further defined and explained in subsequent figures.

In the description of the embodiments of the present invention, it should be noted that orientation or position relationships indicated by terms, such as “center”, “up”, “down”, “left”, “right”, “vertical”, “horizontal”, “inside” and “outside”, are orientation or position relationships based on the drawings, or orientation or position relationships when a product of the present invention is usually placed during use, only to facilitate the description of the present invention and simplify the description, rather than to indicate or imply that a device or an element referred to needs to have a specific orientation or be constructed and operated in a specific orientation, and therefore shall not be understood as limitations to the present invention. In addition, terms, such as “first” and “second”, are only used to differentiate the description and shall not be understood as indicating or implying relative importance.

In addition, terms, such as “horizontal” and “vertical”, do not mean that a component is required to be absolutely horizontal or vertical, while the component can be slightly tilted. For example, the “horizontal” only means that a direction is more horizontal than the “vertical”, and does not mean that a structure needs to be completely horizontal, while the structure can be slightly tilted.

In the description of the embodiments of the present invention, it should also be noted that, unless otherwise clearly stated and limited, terms, such as “arrange” and “connect”, should be understood in a broad sense. For example, a fixed connection, a detachable connection, or an integral connection may be used; a mechanical connection or an electrical connection may be used; and a direct connection, an indirect connection through an intermediate medium, or an internal connection between two elements may be used. For persons of ordinary skill in the art, the above terms may be understood to have specific meanings in the present invention according to specific circumstances.

### EMBODIMENT

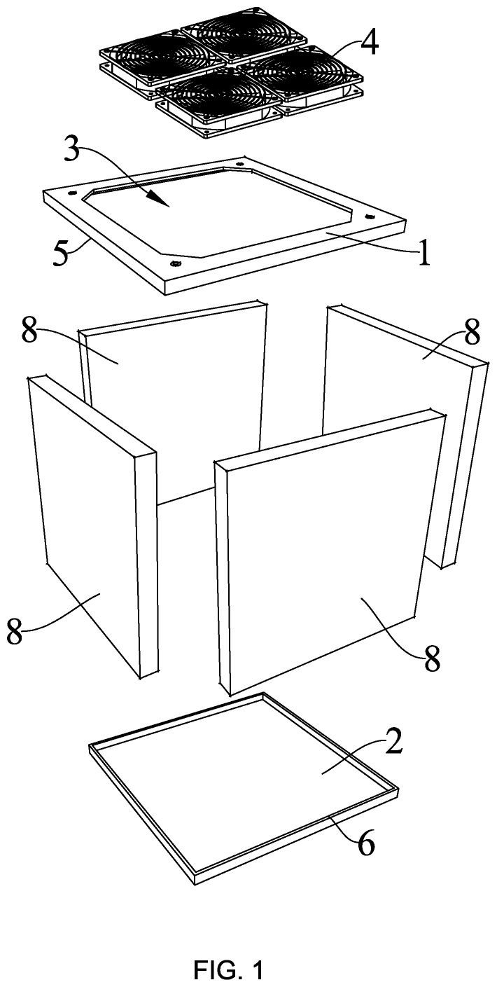

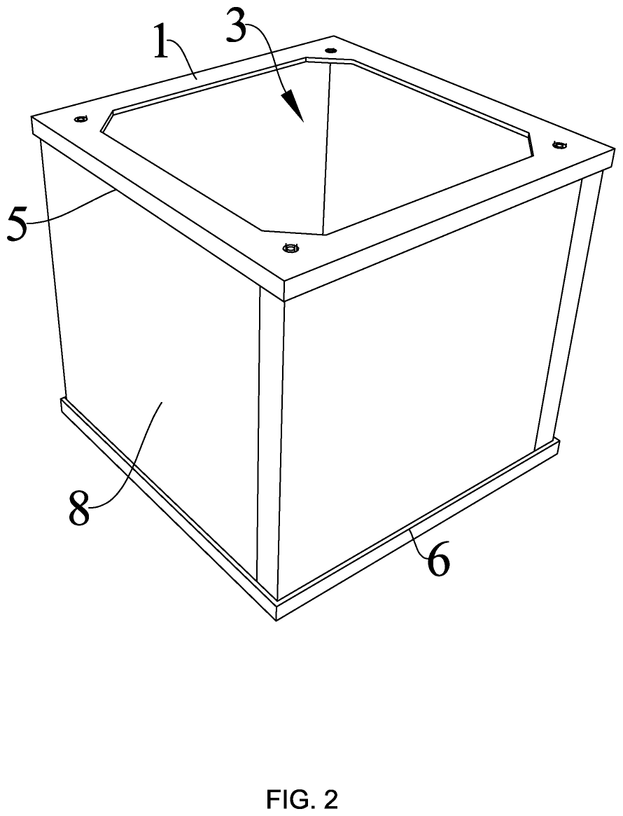

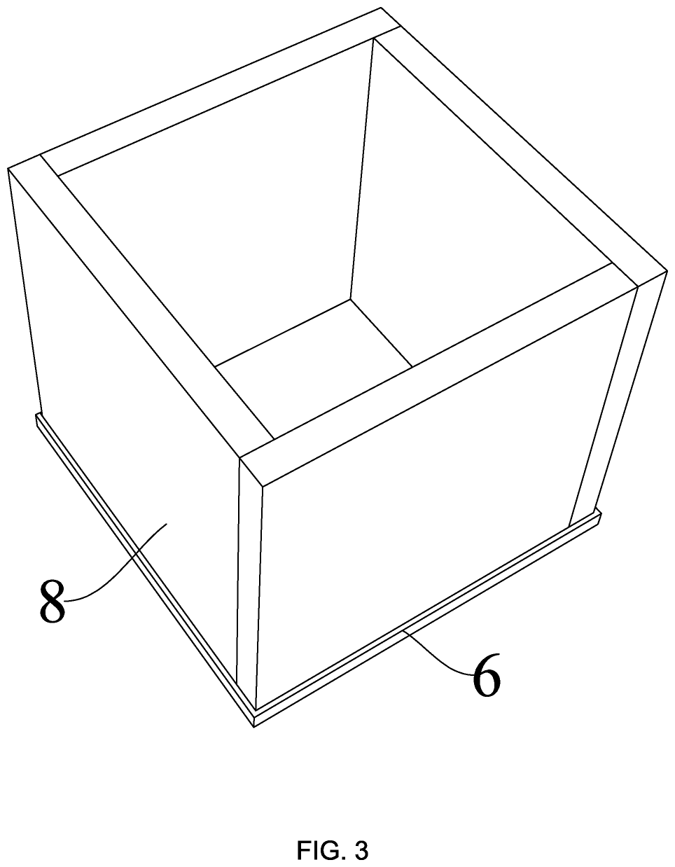

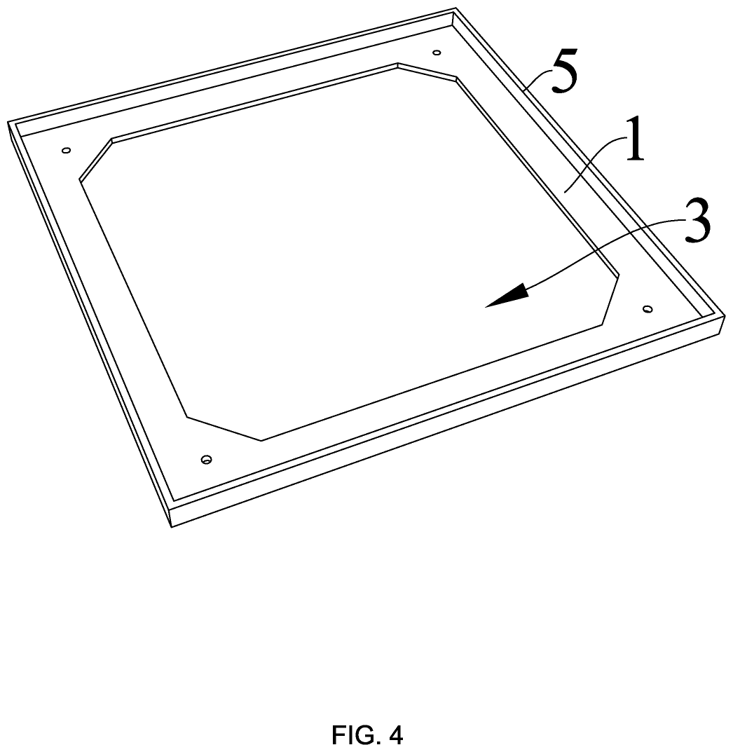

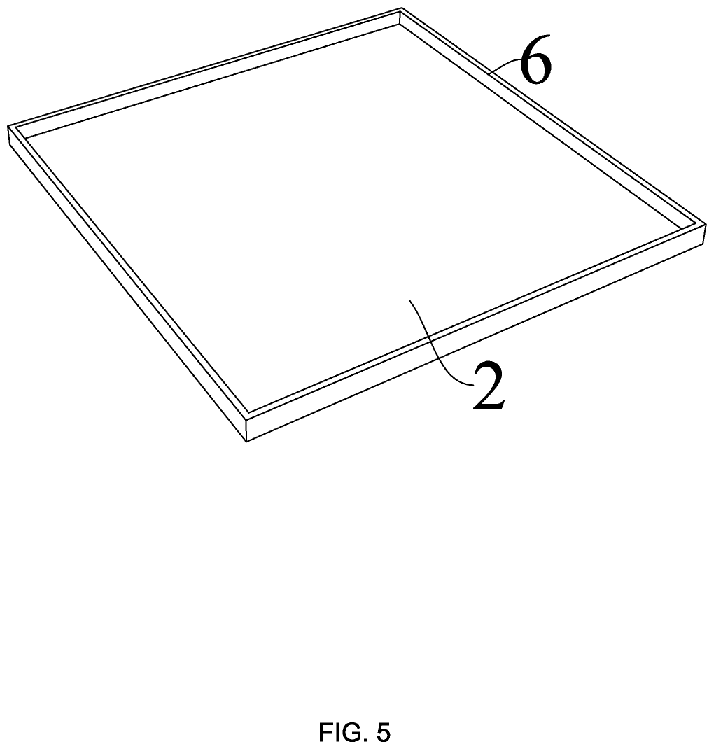

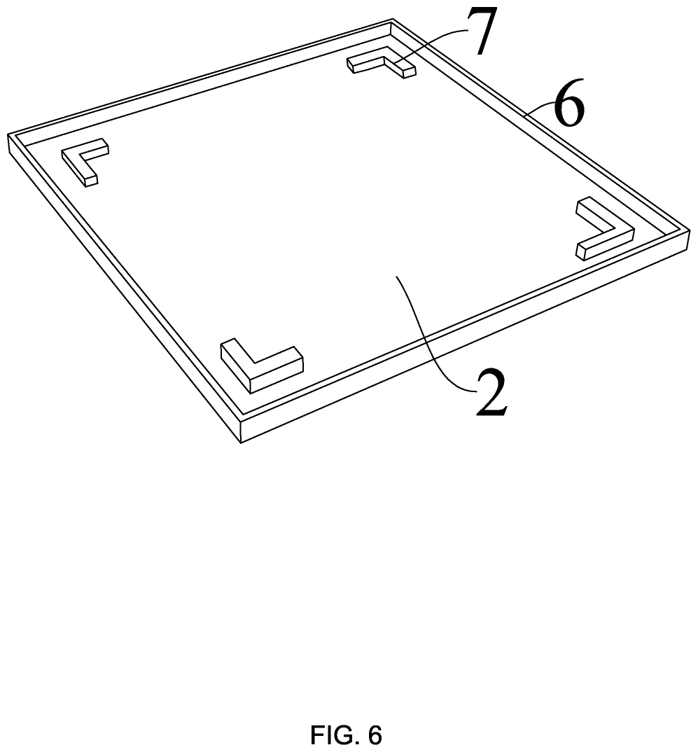

With reference to FIG. 1 to FIG. 6, this embodiment provides an air purifier. The air purifier comprises an air filter box with openings at a top and a bottom, and further comprises a top plate 1 covering the opening at the top of the above air filter box and a bottom plate 2 covering the opening at the bottom of the above air filter box. The above top plate 1 and the above bottom plate 2 are both detachably connected with the above air filter box; and the above top plate 1 is provided with an air inlet and outlet 3, and the above top plate 1 is provided with an air extraction assembly located at the above air inlet and outlet 3. The air extraction assembly comprises at least one fan 4, and the above fan 4 is arranged on the above top plate 1 and located at the above air inlet and outlet 3. A number of the fan 4 may be set according to actual situations. As shown in FIG. 1, preferably, four fans 4 that are connected with each other are used in this embodiment, and the four fans 4 are fixed to the top plate 1.

A bottom of the above top plate 1 is provided with a first limiting frame 5, and the above air filter box is located in the above first limiting frame 5 and abuts against an inner side wall of the above first limiting frame 5. A top of the bottom plate 2 is provided with a second limiting frame 6, and the above air filter box is located in the above second limiting frame 6 and abuts against an inner side wall of the above second limiting frame 6. The top of the bottom plate 2 is provided with clamping blocks 7, and the above air filter box abuts between the above clamping blocks 7 and the above second limiting frame 6. Through arrangement of the clamping blocks 7, the air filter box can be abutted and fixed by the clamping blocks 7, thereby improving the stability of fixing the air filter box.

The air filter box comprises a plurality of air filter screens 8, and the plurality of air filter screens 8 above sequentially abut against each other and surround to form the above air filter box. Existing devices are used as the air filter screens 8. Preferably, HEPA filter screens are used as the air filter screens 8 in this embodiment. A number of the air filter screens 8 is set according to actual situations. Preferably, the number of the air filter screens 8 in this embodiment is four, and a cross section of the above air filter box is rectangular.

In actual use, the various air filter screens 8 are sequentially placed vertically at the top of the bottom plate 2, and the air filter screens 8 are close to an outer side wall of a bottom and abut against an inner side wall of the second limiting frame 6. In this way, the various air filter screens 8 are sequentially installed at the top of the bottom plate 2, and the various air filter screens 8 can sequentially undergo abutting. Then, the top plate 1 is covered at the top of the air filter box, and an outer side wall, close to a top edge, of the air filter box abuts against an inner side wall of the first limiting frame 5 of the top plate 1. In this way, the air filter box is clamped and fixed by the top plate 1 and the bottom plate 2, and installation of the entire air purifier is completed. No additional tools require to be used in a whole installation process, only hands are required to be used for operation, and the operation is simple.

After the air purifier is installed, the fan 4 is turned on. The fan 4 rotates and blows air in the air filter box to an outside after being turned on. At this time, a negative pressure is generated in the air filter box. Under the action of the negative pressure, indoor air can be filtered by the various air filter screens 8, flows into the air filter box and is blown out by the fan 4, such that surrounding air is filtered and purified, and cleanliness of the indoor air is improved.

When the air purifier needs to be carried, only the top plate 1 needs to be manually moved upwards with hands, and the various air filter screens 8 are taken out from the bottom plate 2. At this time, the air purifier is detached into a plurality of flat-shaped structures, which is small in volume after the completion of detaching and can be placed in a suitcase, etc. for carrying, using locations of the air purifier are flexible, and convenience is brought to use by a user.

The above description only shows preferred embodiments of the present invention, and is not used for limiting the present invention. For person skilled in the art, the present application is obviously not limited to the details of the above exemplary embodiments, and the present application can be implemented in other specific forms without departing from the spirit or basic features of the present application.

Therefore, the embodiments should be regarded as exemplary and non-restrictive from any point of view, the scope of the present application is defined by the appended claims rather than the above description, and it is therefore intended that meanings of equivalent elements and all changes falling within the scope of the claims should be included within the present application. Any reference signs in the claims shall not be construed as limiting the claims concerned. For persons skilled in the art, the present invention may have various modifications and changes. Any modifications, equivalent substitutions, improvements and the like made within the spirit and principles of the present invention shall be included in the scope of protection of the present invention.

What is claimed is:

1. An air purifier, characterized in that, the air purifier comprises an air filter box with openings at a top and a bottom, and further comprises a top plate covering the opening at the top of the air filter box and a bottom plate covering the opening at the bottom of the air filter box, and the top plate and the bottom plate are both detachably connected with the air filter box; and the top plate is provided with an air inlet and outlet, and the top plate is provided with an air extraction assembly located at the air inlet and outlet.

2. The air purifier according to claim 1, characterized in that, the air extraction assembly comprises at least one fan, and the fan is arranged on the top plate and located at the air inlet and outlet.

3. The air purifier according to claim 1, characterized in that, a bottom of the top plate is provided with a first limiting frame, and the air filter box is located in the first limiting frame and abuts against an inner side wall of the first limiting frame.

4. The air purifier according to claim 1, characterized in that, a top of the bottom plate is provided with a second limiting frame, and the air filter box is located in the second limiting frame and abuts against an inner side wall of the second limiting frame.

5. The air purifier according to claim 4, characterized in that, the top of the bottom plate is provided with clamping blocks, and the air filter box abuts between the clamping blocks and the second limiting frame.

6. The air purifier according to claim 1, characterized in that, the air filter box comprises a plurality of air filter screens, and the plurality of air filter screens sequentially abut against each other and surround to form the air filter box.

7. The air purifier according to claim 6, characterized in that, a number of the air filter screens is four, and a cross section of the air filter box is rectangular.
